(19) United States
(12) Patent Application Publication
(10) Pub. No.: US 2026/0099493 A1
(43) Pub. Date: Apr. 9, 2026

(54) DATABASE QUERY METHOD IN CENTRALIZED INFRASTRUCTURE

(71) Applicant: DoorDash, Inc., San Francisco, CA (US)

(72) Inventors: Matt Graveen, Woodbury, MN (US); Brad Busch, San Francisco, CA (US); Gordon Lee, San Francisco, CA (US); Joanna Smulska, San Francisco, CA (US); Zulfikar Imani, Chicago, IL (US)

(73) Assignees: DoorDash, Inc., San Francisco, CA (US); DoorDash, Inc., San Francisco, CA (US)

(21) Appl. No.: 19/348,142

(22) Filed: Oct. 2, 2025

Related U.S. Application Data
(60) Provisional application No. 63/703,773, filed on Oct. 4, 2024.

(51) Int. Cl. G06F 16/2453

(52) U.S. Cl. CPC G06F 16/24542

(57) ABSTRACT

A method is disclosed. The method includes receiving, by a server computer from a client computer, a query relating to stored records stored in a database, the query being from a user. The method also includes determining, by the server computer and using a large language model, a query structure from the query, and determining, by the server computer, features useful to answering the query. The method also includes generating, by the server computer, a database query using at least the query structure and the features, retrieving, by the server computer, data from the database using the database query, and outputting, the server computer, an answer to the query to the client computer.

### CROSS REFERENCE TO RELATED APPLICATIONS

This application is a non-provisional application of U.S. Patent Application No. 63/703,773, filed on Oct. 4, 2024, which is herein incorporated by reference in its entirety for all purposes.

### SUMMARY

One embodiment of the invention comprises a method. The method comprises: receiving, by a server computer from a client computer, a query relating to stored records stored in a database, the query being from a user; determining, by the server computer and using a large language model, a query structure from the query; determining, by the server computer, features useful to answering the query; generating, by the server computer, a database query using at least the query structure and the features; retrieving, by the server computer, data from the database using the database query; and outputting, the server computer, an answer to the query to the client computer.

Another embodiment is related to a server computer comprising a processor, and a non-transitory computer readable medium. The non-transitory computer readable medium comprising code, executable by the processor, for performing a method. The method comprises: receiving, from a client computer, a query relating to stored records stored in a database, the query being from a user; determining, using a large language model, a query structure from the query; determining features useful to answering the query; generating a database query using at least the query structure and the features; retrieving data from the database using the database query; and outputting an answer to the query to the client computer.

Further details regarding embodiments of the disclosure can be found in the Detailed Description and the Figures.

### BRIEF DESCRIPTION OF THE DRAWINGS

FIG. 1 shows a system according to embodiments of the invention.

FIG. 2 shows a diagram of a server computer according to embodiments of the invention.

FIG. 3 shows a first flow diagram according to an embodiment of the invention.

FIG. 4 shows an exemplary diagram of a feature extractor according to embodiments.

FIG. 5 shows a second flow diagram according to another embodiment of the invention.

FIG. 6 shows a diagram of a tool selector according to an embodiment.

FIG. 7 shows an exemplary user interface according to embodiments.

### DETAILED DESCRIPTION

Prior to discussing specific embodiments of the invention, some terms can be described in further detail.

A “user” may include an individual. In some embodiments, a user may be associated with one or more personal accounts and/or mobile devices. In some embodiments, the user may be a consumer.

A “client device” may be any suitable electronic device that can process and communicate information to other electronic devices. The user device may include a processor, and a computer-readable medium coupled to the processor, the computer-readable medium comprising code, executable by the processor. The user device may also each include an external communication interface for communicating with other entities. Examples of user devices may include a mobile device, a laptop or desktop computer, a wearable device, etc.

A “server computer” is typically a powerful computer or cluster of computers. For example, the central server computer can be a large mainframe, a minicomputer cluster, or a group of servers functioning as a unit. In one example, the central server computer may be a database server coupled to a Web server. The central server computer may also be a cloud based server.

A “feature” can be an individual measurable property or characteristic of a phenomenon. A feature can be described by a feature vector. A feature can be input into a model to determine an output. As an example, in pattern recognition and machine learning, a feature vector is an n-dimensional vector of numerical features that represent some object. Algorithms in machine learning require a numerical representation of objects since such representations facilitate processing and statistical analysis. When representing images, the feature values might correspond to the pixels of an image. When representing text, however, the features might be the frequencies of occurrence of textual terms. Feature vectors are equivalent to the vectors of explanatory variables used in statistical procedures such as linear regression. Feature vectors can be combined with weights using a dot product in order to construct a linear predictor function that is used to determine a score for making a prediction.

“Machine learning” can include an artificial intelligence process in which software applications may be trained to make accurate predictions through learning. The predictions can be generated by applying input data to a predictive model formed from performing statistical analyses on aggregated data. A model can be trained using training data, such that the model may be used to make accurate predictions. The prediction can be, for example, a classification of an image (e.g., identifying images of cats on the Internet) or a recommendation (e.g., a movie that a user may like or a restaurant that a consumer might enjoy).

A “model” can include a computer program that is designed to simulate what might occur in a situation given various inputs. A model can be a machine learning model. A model can receive input data and determine an output. User features and service provider features can be input into a model to determine an output of a cart.

A “machine learning model” may include an application of artificial intelligence that provides systems with the ability to automatically learn and improve from experience without explicitly being programmed. A machine learning model may include a set of software routines and parameters that can predict an output of a process (e.g., identification of an attacker of a computer network, authentication of a computer, a suitable recommendation based on a user search query, etc.) based on feature vectors or other input data. A structure of the software routines (e.g., number of subroutines and the relation between them) and/or the values of the parameters can be determined in a training process, which can use actual results of the process that is being modeled, e.g., the identification of different classes of input data. Examples of machine learning models include support vector machines (SVM), models that classify data by establishing a gap or boundary between inputs of different classifications, as well as neural networks, collections of artificial “neurons” that perform functions by activating in response to inputs.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “tool” can be a system component that interfaces an application with other programs or data sources in its environment. It can perform a bounded operation over one or more data domains (e.g., executing a SQL query) and emit a structured result, configurable via parameters (or alternatively features) to fit individual contexts. The tool can be an atomic or composite unit defined by a capability descriptor that binds it to specific subject areas and intents (e.g., accounts receivable) and exposes a formal parameter interface specifying the inputs relevant to the operation (e.g., invoice identifiers, date ranges, entity names). The tool may further include an execution binding (e.g., a Jinja-templated SQL statement) that, when combined with values supplied through the parameter interface, realizes the operation.

A “tool parameter structure” can be a machine-readable, versioned schema that specifies and binds the inputs required to instantiate a tool and realize its execution. A parameter structure can include parameters (e.g., features) which can be a special kind of variable used in a function or method definition to refer to one of the pieces of data provided as input to the function, acting as a placeholder for the actual value (argument) supplied at invocation. The parameter structure can enumerate field names and data types, defaults (including dynamic defaults such as “current fiscal period”), and other relevant variables such as customer names and dates

Embodiments of the invention can include an application running on a server computer. The application can streamline workflows (such as accounting workflows) by enabling a team (e.g., an accounting team) to easily query, reconcile and perform analyses on data (e.g., accounting data) across different subject areas. The different subject areas are accounting subject areas such as AR (accounts receivable), AP (accounts payable), revenue, assets, etc. The users of server computer can be, for example, accountants or their managers or subordinates.

In some embodiments, the technical components of the application can include multiple services running on a cloud service account interacting with financial accounting data on an accounting instance and a database where accounting specific templates and spreadsheets are stored. The application can enable a conversational experience by leveraging generative AI (artificial intelligence) services and LLMs provided by various entities.

In particular, embodiments of the invention improve the methods for quickly generating database queries that improve the quality of data retrieval from databases. The quality of data such as accounting data is desirable, as it is often used in decision-making processes.

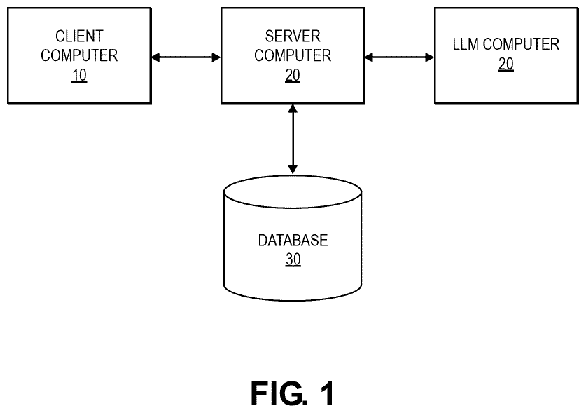

FIG. 1 shows a system according to an embodiment of the invention. The system includes a client computer 10 in communication with a server computer 20. The server computer 20 can be in communication with an LLM (large language model) computer 20 and a database 30. The LLM computer 20 can have a large language model (LLM). In some embodiments, the LLM be on the server computer 20. The database 30 may include an SQL database. Although one client computer, one server computer, one database 30, and one LLM computer are shown for illustration, it is understood that embodiments of the invention can include any number of these components.

Each of the entities in FIG. 1 may communicate through any suitable communication channel or communications network. A suitable communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

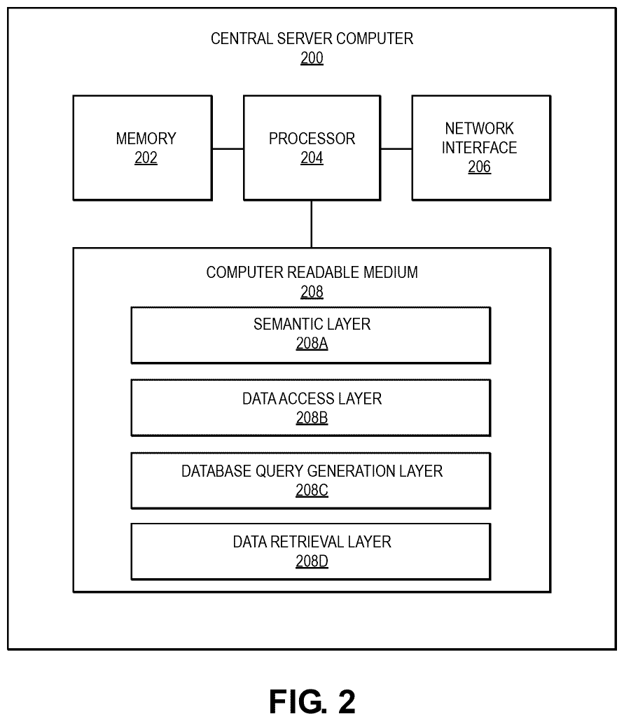

FIG. 2 shows a block diagram of a central server computer 200 according to embodiments. The exemplary central server computer 200 may comprise a processor 204. The processor 204 may be coupled to a memory 202, a network interface 206, and a computer readable medium 208.

The memory 202 can be used to store data and code. The memory 202 may be coupled to the processor 204 internally or externally (e.g., cloud based data storage), and may comprise any combination of volatile and/or non-volatile memory, such as RAM, DRAM, ROM, flash, or any other suitable memory device.

The computer readable medium comprising code, executable by the processor 204 to perform a method comprising: receiving, from a client computer, a query relating to stored records stored in a database, the query being from a user; determining, using a large language model, a query structure from the query; determining features useful to answering the query; generating a database query using at least the query structure and the features; retrieving data from the database using the database query; and outputting an answer to the query to the client computer.

The computer readable medium 208 can comprise one or more components that may form an application. The computer readable medium 208 can comprise a semantic layer 208A, a data access layer 208B, a database query generation layer 208C, and a data retrieval layer 208D.

As will be described below in some embodiments, the semantic layer 208A may include a query reformulator and a feature extractor. In other embodiments the semantic layer 208A may include an input guard, a router, and a semantic mapper.

The data access layer 208B may include a policy enforcer in some embodiments. The policy enforcer can enforce appropriate data access policies.

The database query generation layer 208C can be an SQL query generation layer and can include a selector, a generator, and a validator in some embodiments.

The data retrieval layer 208D can include a database query executor such as an SQL executor in some embodiments.

The network interface 206 may include an interface that can allow the central server computer to communicate with external computers. The network interface 206 may enable the central server computer 104 to communicate data to and from another device (e.g., one or more user devices, one or more transporter user devices, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

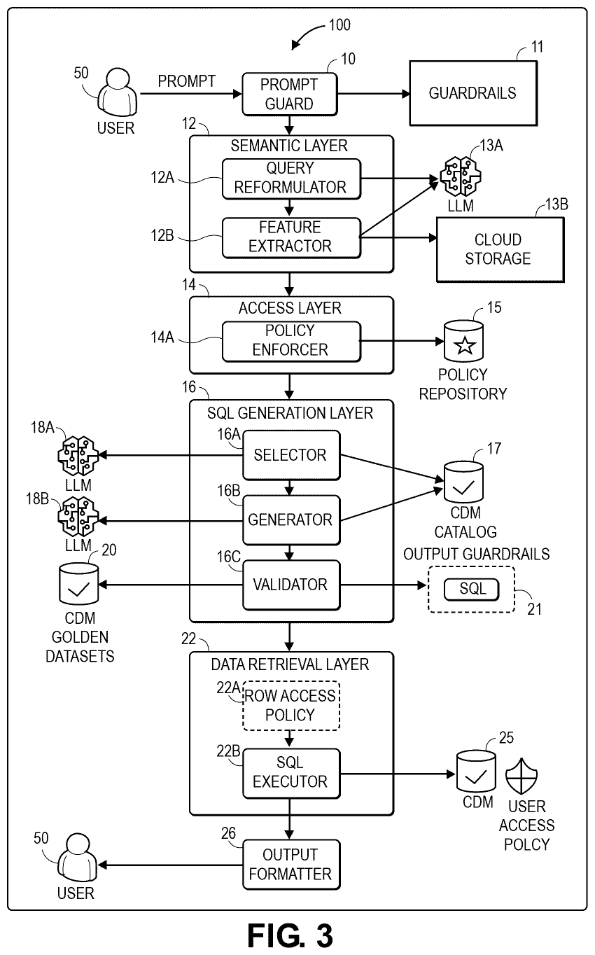

FIG. 3 shows a first prompt data flow diagram illustrating embodiments of the invention. The process flow in FIG. 3 allows a user to provide any type of query and receive an accurate answer to that query. A database query such as a SQL query is automatically generated using the process flow. The various functions described with respect to FIG. 3 can be part of an application.

Initially, the user 50 can input into the client computer a raw query for information such as stored record (e.g., accounting information) stored in a database. The prompt might be, for example, “What are the invoices that are due next week for customer ‘XYZ”. The prompt is then transmitted to the server computer.

Once the user's raw query is received by the server computer, a prompt guard 10 can use input guardrails 11. The guardrails 11 ensure that users interact with the application in an accounting context without exposing sensitive PII (personal identifiable information) data through prompts. The guardrails 11 also ensure that the prompt is safe for the work environment, and that the prompt is not out of context for the specific accounting subject area(s) managed by the application. The guardrails can also be used to guard against queries that are not relevant to accounting (e.g., what is the temperature today?) or queries that may be detrimental to the system (e.g., can you delete the data in the system?).

The application can also have output guardrails that can ensure that users are presented with information that is not harmful. By using the output guardrails, LLM hallucinations from the LLMs that are used are minimized and handled appropriately. Output guardrails can ensure that the LLM(s) does not expose sensitive system level information like underlying tables, system prompts or configuration details to the user.

The key output from the LLM(s) is the SQL query it generates based on the Accounting Common Domain Model (CDM). The CDM is a standardized, machine-readable, and machine-executable blueprint for representing financial products, their lifecycle events, and associated processes, primarily developed and maintained by industry associations. This output is guarded using an SQL guard to ensure that it is a syntactically valid SELECT query generated by the LLM. It serves as a universal data dictionary and process model, fostering automation and reducing operational issues like reconciliation and valuation disputes. A CDM can include core accounting models including chart of accounts, subsidiaries, account segments, account registered, consolidated financials, fiscal periods, vendors, and customers. It can also have subject area specific models and data such as AR transactions, AR models, AP transactions, and AP models.

After passing through the guardrails 11, the query is processed by a semantic layer 12

The semantic layer 12 can include the components and heuristics needed to extract and structure the right information and context from the user's prompt that in turn becomes the input context to the SQL Generation Layer 16 (an example of a database query generation layer). The semantic layer 12 can have a query reformulator 12A and a feature extractor 12B. The feature extractor also interfaces with a cloud storage 13B. The query reformulator 12A and the feature extractor 12B can interface with an LLM 13A.

The semantic layer 12 can include an accounting master data indexing engine. This is the stage where all specific accounting data elements like chart of accounts, customers, fiscal periods, vendors, subsidiaries and departments, etc. are prepared and indexed for fast keyword based retrieval. This indexing engine is an offline/batch process that can run on a set schedule (every day/week) to keep the different indexes up to date with the updates of the data. The indexed data can be stored in the cloud storage 13B.

The query reformulator 12A can take a raw query that lacks the necessary context, and can rewrite it using the LLM 13A so that it makes sense on its own. The query reformulation process used by the query reformulator 12A can consider the user's chat history in the current session to determine what additional context needs to be included to rewrite the raw query.

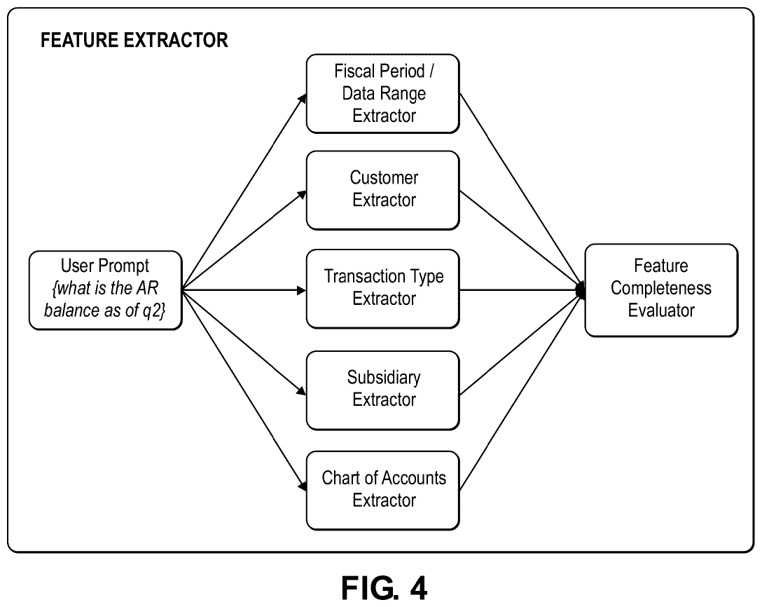

The feature extractor 12B takes the reformulated query and extracts a collection of features (e.g., accounting features) that describe attributes might yield useful database queries. Additional details of the operation of the feature extractor 12B are shown in FIG. 4. As shown in FIG. 4, the feature extractor 12B can look for feature types such as fiscal period and date ranges, customer and vendor names, chart of accounts, subsidiary names, transaction types, etc. The feature extractor 12B can have specific extractors corresponding to the above feature types. Each specific extractor can be optimized to extract a specific feature type and may in turn leverage the LLM 13A, keyword store or a semantic store. Having these specific extractors be independent of each other enables a degree of modularity that makes them easier to test and evolve. Once the features are extracted from the query (e.g., “what is the AR or accounts receivable balance as of Q2?”), a feature completeness evaluator may evaluate the completeness of the identified features.

The output of the semantic layer 12 may be provided to an access layer 14. The access layer 14 can comprise a policy enforcer 14A that checks to see if the user as access given their role. For example, a CFO (chief financial officer) may have access to all records. However, an entry level accounts receivable analyst may not have access to all records. The policy enforcer 14A can obtain policies regarding data access from a policy repository 15.

The output of the access layer 14 can be provided to the SQL generation layer 16 (or generically a database query generation layer). The SQL generation layer can generate the final SQL query using the user's intent, extracted accounting features/criteria, and schema of a common domain model (CDM) catalog using an SQL dialect (e.g., a Snowflake™ SQL dialect). The objective of the SQL generation layer is to generate the most accurate SQL statement that can answer the user's query. The SQL generation layer 16 can have a selector 16A, a generator 16B, and a validator 16C.

The selector 16A makes a call to an LLM 18A providing the context around the user's query, criteria and the list of tables available in the CDM catalog 17. The LLM 18A then provides a list of tables that need to be queried to best answer the user's query. This helps narrow down the context of the tables required to be queried. The output of the selector 16A is then passed to the generator 16B.

The generator 16B makes a call to the LLM 18B passing the user's refined prompt, the extracted features, and CDM schema of all tables selected by the selector 16A and their PK< >FK (primary key and foreign key) relationships. The generator 16B may also send a few shot SQL examples and sample data rows from the tables to be queried to the LLM 18B. The output of the generator 16B is an SQL statement that can then be passed to the validator 16C.

The validator 16C takes the SQL statement generated by the generator 16B and validates it for syntactic and factual consistency. In addition, basic guardrails 21 are applied to ensure that the SQL generated is only a SELECT statement and not a DML or ALTER operation.

The factual consistency check would have: (1) the LLM output SQL evaluated against the ground truth SQL; (2) user feedback from the tool on the generated output (this will then be used to improve the accuracy of application); (3) output validated against predefined golden datasets 20 and KPIs (key performance indices); and (4) extensive LLM evaluations to be run during the test and release phases.

An example prompt, named entities and extracted features, and an exemplary SQL query are below.

| | named entities | |
|---|---|---|
| prompt | features (with context) | CDM SQL (Ground truth) |
| What are the invoices | Transaction Type = Invoices | SELECT “INVOICE_NUMBER”, |
| that are due next | Date Range: Next Week | “INVOICE_DUE_DATE”, |
| week for customer | Customer: xyz (looks up the customer | “TOTAL_INVOICE_DUE_AMO |
| “XYZ”? | index to get list of all matching customer | UNT” |
| | records with their IDs) | FROM |
| | | “FINCOPILOT_CDM”.“account |
| | | s_receivable”.“ar_customer_i |
| | | nvoices” |
| | | WHERE |
| | | “INVOICED_TO_CUSTOMER_{—} |
| | | NAME” = ‘XYZ’ |
| | | AND “INVOICE_DUE_DATE” |
| | | BETWEEN DATEADD(day, 1, |
| | | DATE(‘now’)) AND |
| | | DATEADD(day, 7, |
| | | DATE(‘now’)) |

The output of the SQL generation layer 16 is provided to the data retrieval layer 22. The data retrieval layer 22 can include a row access policy module 22A and an SQL executor 22B. The data retrieval layer 22 can use a correct role and connection to execute the SQL statement generated by the SQL generation layer 16 against accounting instance subject area specific CDM schema tables 25. The data retrieval layer 22, if required, also writes the SQL output to a spreadsheet program and can serve up a link to a spreadsheet to the user 50.

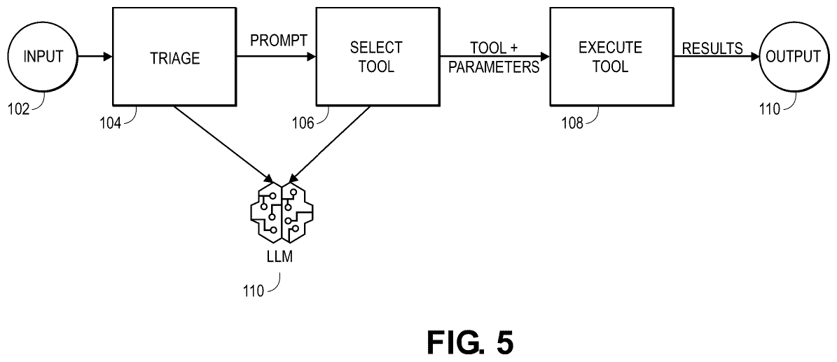

FIG. 5 shows a second data flow diagram illustrating embodiments of the invention, which can be run using the server computer. The process flow in FIG. 5 allows a user to provide any type of query and receive an accurate answer to that query. A database query such as a SQL query is automatically generated using the process flow. The process flow uses AI agents and tools.

In the process flow of FIG. 5, an input 102 comprising a raw query is received by the server computer from the user via the client computer. The raw query can relate to stored records (e.g., accounting data) stored in a database.

The raw query is then provided to a triager in a triage phase 104, which is in communication with an LLM 110. The triage phase has context around the different capabilities of the application in terms of agents, tools and CDM metadata (data dictionary) and the user's role, permissions and data entitlements. The triager enables users to ask, in natural language, what the application is capable of. Alternatively or additionally, the users can ask what accounts, subsidiaries, cost centers, etc. the user has access to. For example, users can ask for “Can I get invoices by campaign id” and the triager would reply with “Yes, you can and here is a sample prompt to get invoices by campaign-id” or “How recent is the data” and the triager would reply with “The data was last refreshed on Jun. 12, 2025, 11:32 am PT and the next refresh cycle is on xxx”. The user can have a conversation with the application and clearly understand what is possible in context of the user's role, permissions and data access policy (querying for AR data vs. posting journal entries). The triager also hands off the user's query to the next stage of the pipeline once the user's intent is clear in terms of whether the user is asking for a report, trying to create a task or reconciling data.

In the triage stage 104, the triager can output a revised prompt to a tool selector in a select tool stage 106. The tool selector has context around the different agents and tools in an agent tool registry which expose the capabilities of the application grouped by logical accounting subject areas and topics. These agents and tools are configured in registries and stored in the application's configuration database. At run-time, the tool selector fills the system prompt templates with the appropriate agents, tools and parameter structures and passes it to the LLM 110. The LLM 110 then outputs the right tool and parameters (e.g., features) required to perform the user's request. The tool selector also outputs the LLM's reasoning summary which is used for explainability and improving the system.

In some embodiments, the tool selector outputs a single tool that best matches the user's intent. In other embodiments, the tool selector can output a tool execution DAG (directed acyclic graph) with tool dependencies to answer more complex user queries. For example, the tool to get the subsidiaries and get the aging details for each subsidiary are currently different tools that can be “orchestrated” to get the aging details for all subsidiaries grouped by subsidiary. In some embodiments, the tool can include a query structure such as a query template that can be used to generate a database query.

The tool selector can also have built-in guardrails to ensure off-topic and unsupported requests are classified and communicated back to the user.

After the tool selector in the select tool stage 106 processes the prompt from the triage stage 104, a tool(s) and parameters (e.g., features) are provided by the tool selector to a tool executor in a tool execution phase 108. The tool execution phase 108 produces the output 110 to the original raw query from the user. In some embodiments, the output 110 can be formatted before it is provided to the user.

A tool executor in the tool executor stage 108 executes the tool selected by tool selector. In some embodiments, the tool executor can execute SQL-based tools that get data from an Accounting Common Domain Model (CDM). It can generate an SQL statement based on a query template (e.g., a Jinja template) and the tool (which may include the query template) and parameters (e.g., features) passed from the tool selector. The generated SQL statement is then executed against the CDM tables (e.g., data in a database) using a service account and the correct role that has access to the required schemas in the CDM.

In some embodiments, the tool executor also writes the output data from the CDM to a file (e.g., a parquet file) into a bucket (e.g., an S3 bucket) for the user so that the user can download the full dataset if required and for auditability and traceability. The tool executor can be synchronous or asynchronous.

The user's prompt, tool selection details, tool execution details like the Jinja file, SQL generated, parquet file path, semantic version of tool parameters etc. can all stored in a prompt memory table in a data storage that can be queried or recalled by different services as needed.

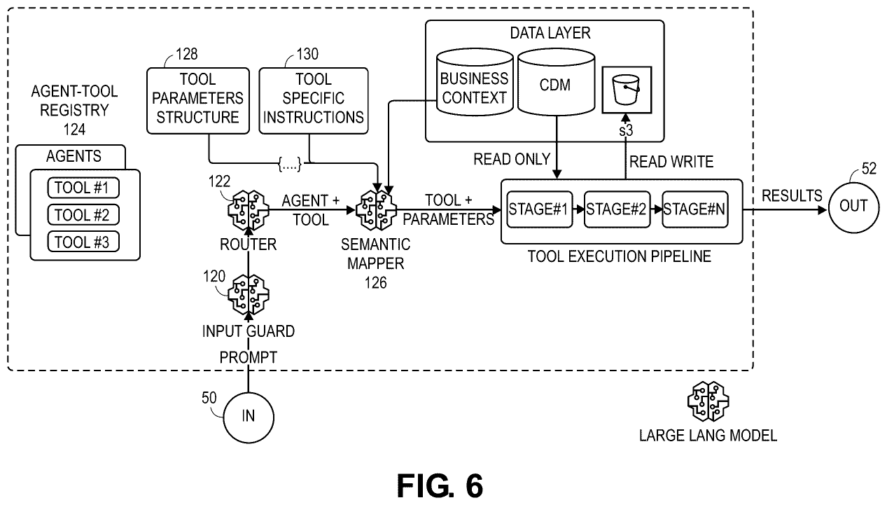

A diagram showing components in the tool selector phase and the tool execution phase is shown in FIG. 6. FIG. 6 shows an agent-tool registry with AI agents and tools. As shown, the input 50 is processed by an input guard 120. The output from the input guard 120 can be provided to a router 122. The router 122 can also communicate with the agent-tool registry to obtain an agent and tools suitable to process the input 50. The agents may be AI agents that are specifically configured to perform specific functions as AR invoicing, AP payments, account registers, customer/vendor expenses, etc. Examples may include a get AR invoices tool, a get AP list tool, etc.

The router 122 can provide the selected agent and tool to a semantic mapper 12. The semantic mapper 126 can obtain a tool parameters structure 128 and tool specific instructions 130 associated with the selected tool. In some embodiments, the tool specific instructions 130 can include instructions on how a tool can be executed.

The semantic mapper 126 can also obtain business context data 132 from a data layer. The semantic mapper 126 can be an LLM. In some embodiments, the semantic mapper 126, given the selected agent and tool, the tool's parameter structure, tool-specific instructions, and the business data layer (e.g., a Common Domain Model catalog and business context), translates a user's raw natural-language query into a populated parameter structure object with parameters (e.g., features), and an executable instruction for the tool. The semantic mapper 126 can therefore determine the parameters (e.g., features). In operation, the semantic mapper interprets business terms, binds user-supplied arguments to the tool's parameters, resolves natural language terms to entities defined in the CDM (e.g., mapping “Subsidiary Alpha” to subsidiary_id), applies defaults and constraints from the parameter schema (e.g., “last fiscal period,” currency, or time zone), and maps fields to execution placeholders (e.g., Jinja variables, stored procedure arguments, API query params). The output can be a ready-to-run operation (SQL query to run against the CDM). For example, given “show invoice aging for Subsidiary Alpha last quarter,” the semantic mapper selects the accounts-receivable aging tool, maps “last quarter” to the correct fiscal period per the close calendar, resolves the subsidiary to its ID in the CDM, fills any aging bucket settings specified by the tool instructions, and emits the populated parameters and bindings for deterministic execution.

The input guard 120, the router 122, and the semantic mapper 126 can each be an LLM.

The semantic mapper 126 can then output the tool and parameters to a tool executor, which can perform a tool execution pipeline 134. The tool execution pipeline may include a first stage which generates the database query using the tool and the parameters. A second stage in the tool execution pipeline 134 can execute the database query against data in the database in the data layer. A third stage in the tool execution pipeline 1340 can output a file into an S3 bucket for the user to be able to download the full dataset.

The evaluation framework can cover the following: 1) an LLM output tool and parameters evaluated against the ground truth; and 2) user feedback from the tool on the generated output. This can then be used to improve the accuracy of application

Below is an is an example of a prompt, a tool selector output, and an identification of a table that contains the requested data for generating an SQL query according to the second embodiment. The SQL query can be associated with a question that is asked in June 2025.

| Prompt | Tool Selector Output | CDM SQL |
|---|---|---|
| what are Grocery Store A's | Selected Agent: | Core table: |
| invoices due this month | AR_INVOICING_AGENT | ACCOUNTS_RECEIVABLE.AR |
| | Selected Tool: | _INVOICE |
| | GET_AR_INVOICES | |
| | { | |
| | “customer_name”: “Grocery | |
| | Store A”, | |
| | “invoice_due_date”: [ | |
| | { | |
| | “start_date”: “2025-06-01”, | |
| | “end_date”: “2025-06-30” | |
| | } | |
| | ] | |
| | } | |

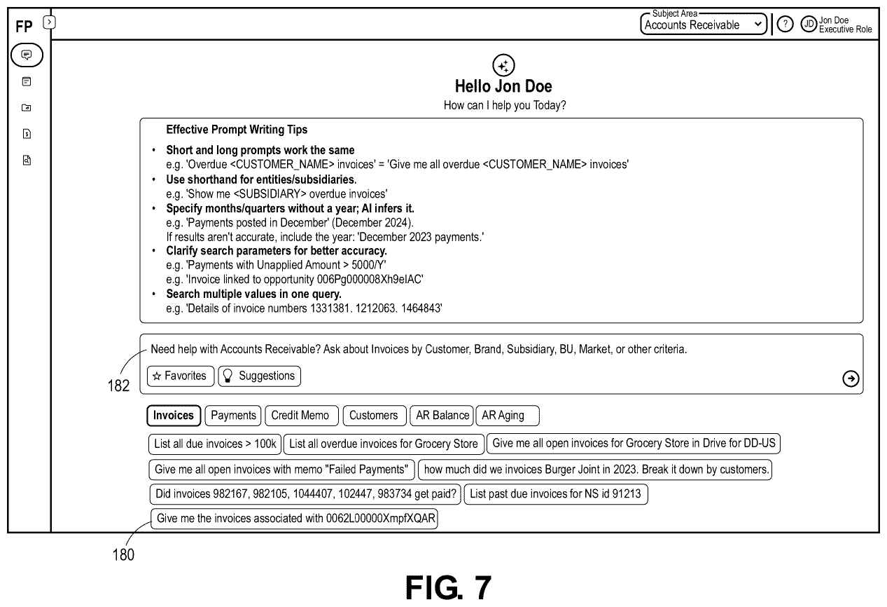

FIG. 7 shows an exemplary user interface according to embodiments. The user interface can include an input window 182 for receiving a raw query, and suggested pre-defined queries 180 that may be chosen by the user.

The application according to embodiments of the invention can have a number of additional features.

The application can have a central landing page for all users, offering a quick overview of task progress. Users can filter to view their personal tasks, their team's tasks, or all tasks across the organization. The dashboard also provides visibility into overdue tasks and tasks due today, helping users prioritize their work.

The application can have a worklist page. This can provide a comprehensive view of all accounting tasks, showing detailed assignments of preparers and approvers. Users can apply filters to quickly access relevant tasks. Once a preparer completes and signs off on a task, the system records the sign-off date and time. Approvers are notified to review and approve completed tasks, ensuring an efficient workflow.

The application can have a command center. This can be a GenAI-powered query platform, enabling users to quickly obtain answers through natural language prompts. Integrated with security protocols, this feature allows users to view results, download data in CSV format, and access original transactions with a single click. Feedback options are provided for users to flag inaccuracies in results, improving system performance over time.

The application can provide a streamlined interface for viewing trial balances, financial statements, and account activity. This integration with the command center enables accountants to access crucial data in one place, reducing the need to switch between different applications to retrieve the same information.

The application can also provide a dedicated view of all the user's JIRA tickets and updates, with a punch-out capability to access the original tickets. This centralized screen consolidates tickets across multiple enterprise projects, ensuring that users can manage open issues efficiently without navigating multiple systems.

The application can also provide a user-friendly interface that provides a quick view of all manual journal entries and their posting status. It serves as a single access point for creating new manual journals, offering an organized, efficient way to manage journal entry tasks. As part of creating new manual journal entries (MJE's), the application can also incorporate industry standard JE validation rules (e.g., debits need to equal credits) to ensure that the MJE's have accurate information before posting to the accounting system of record.”

The application can also provide a unified space for managing reconciliations, allowing users to streamline updates and reviews. Automated alerts notify users when reconciliations are due, ready for review, or when accounts go out of balance, helping to keep the financial close process on track.

The application can also provide a powerful tool for executing flux analysis during the financial close, enabling users to finalize account balances and generate automated reports based on predefined thresholds. Variances from previous periods are highlighted, helping users analyze the underlying factors behind the numbers.

The application can also provide a comprehensive, user-friendly reference manual detailing the business objects and attributes supported by the system. Users can consult this dictionary when querying data with GenAI capabilities or creating reports, making it easier to understand what information is available for analysis.

Other aspects of the invention can include a centralized workspace. Embodiments of the invention can combine all data and input from the accounting and finance applications into one centralized workspace with AI Chat and query functionality that can query from all shared applications. The centralized workspace can serve as a launching pad for tools, and all information is centralized within this workspace design and is able to be queried by the AI Chat.

Embodiments of the invention can also use a Common Domain Model. The use of a combination of complex and simplified LLM layers in this capacity is also unique because it can be an industry focused AI Chatbot that learns from internal data as well as accounting and finance specific publications that are relevant to the industry. It is a curated to each specific subject matter and domain within accounting and finance so that it can differentiate between two similar concepts in different domains (for example, an invoice in AR vs an invoice in AP-same terminology that mean very different things within PTP (procure to pay) and RTR (record to report) functions in Accounting).

Embodiments of the disclosure have a number of advantages. Embodiments of the invention can provide for improved and automated database queries can be quickly generated to retrieve quality data from databases.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a server computer from a client computer, a query relating to stored records stored in a database, the query being from a user;
determining, by the server computer and using a large language model, a query structure from the query;
determining, by the server computer, features useful to answering the query;
generating, by the server computer, a database query using at least the query structure and the features;
retrieving, by the server computer, data from the database using the database query; and
outputting, the server computer to the client computer, an answer to the query.

2. The method of claim 1, wherein the server computer comprises query reformulator, and the query structure is a reformulated query produced using the query reformulator.

3. The method of claim 1, wherein the stored records are accounting records.

4. The method of claim 1, wherein the server computer comprises a query generation layer, and the method further comprises:
applying guardrails to query before determining the query structure, the query structure being a reformulated query produced using the query generation layer.

5. The method of claim 4, wherein the query generation layer comprises a selector that calls a first LLM, a generator that calls a second LLM, and a validator.

6. The method of claim 5, wherein the query generation layer is an SQL query generation layer, and the query is an SQL query.

7. The method of claim 1, wherein the server computer comprises a feature extractor, and the feature extractor determines the features from the query.

8. The method of claim 1, wherein the query structure is a prompt template.

9. The method of claim 1, wherein the query structure is determined using one or more AI agents.

10. The method of claim 1, wherein the server computer comprises a tool selector, and wherein the method further comprises:
selecting, by the tool selector in the server computer, a selected tool, and wherein the database query is further generated using the selected tool.

11. A server computer comprising:
a processor; and
a non-transitory computer readable medium, the non-transitory computer readable medium comprising code executable by the processor, for performing a method comprising:
receiving, from a client computer, a query relating to stored records stored in a database, the query being from a user;
determining, using a large language model, a query structure from the query;
determining features useful to answering the query;
generating a database query using at least the query structure and the features;
retrieving data from the database using the database query; and
outputting an answer to the query to the client computer.

12. The server computer of claim 11, wherein the server computer comprises query reformulator, and the query structure is a reformulated query produced using the query reformulator.

13. The server computer of claim 11, wherein the stored records are accounting records.

14. The server computer of claim 11, wherein the server computer comprises a query generation layer, and the method further comprises:
applying guardrails to query before determining the query structure, the query structure being a reformulated query produced using the query generation layer.

15. The server computer of claim 14, wherein the query generation layer comprises a selector that calls a first LLM, a generator that calls a second LLM, and a validator.

16. The server computer of claim 15, wherein the query generation layer is an SQL query generation layer, and the query is an SQL query.

17. The server computer of claim 11, wherein the server computer comprises a feature extractor, and the feature extractor determines the features from the query.

18. The server computer of claim 11, wherein the query structure is a prompt template.

19. The server computer of claim 11, wherein the query structure is determined using one or more AI agents.

20. The server computer of claim 1, wherein the server computer comprises a tool selector, and wherein the method further comprises:
selecting, by the tool selector in the server computer, a selected tool, and wherein the database query is further generated using the selected tool
